(19) United States
(12) Patent Application Publication
(10) Pub. No.: US 2010/0097913 A1
(43) Pub. Date: Apr. 22, 2010

(54) INFORMATION RECORDING METHOD AND INFORMATION RECORDING APPARATUS

(76) Inventors: Takashi Kikukawa, Tokyo (JP); Koji Mishima, Tokyo (JP)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 12/531,738

(22) PCT Filed: Mar. 10, 2008
(86) PCT No.: PCT/JP2008/000511

§ 371 Date: Sep. 17, 2009

(30) Foreign Application Priority Data
Mar. 28, 2007 (JP) 2007-083495

(51) Int. Cl. G11B 3/74; G11B 7/00

(52) U.S. Cl. 369/94; 369/100; G9B/7

(57) ABSTRACT

An information recording method for a multi-layered optical recording medium that can form information recording layers in 3 layers or more. When all the information recording layers are blank, the information recording layer that is the closest to the light incident surface is irradiated with a laser beam to start recording. High quality information recording is thus implemented in consideration of adherence of foreign matters and occurrence of scratches.

### TECHNICAL FIELD

The present invention relates to a method for recording information on a multi-layered optical recording medium which may be made of a plurality of information recording layers, and to an information recording apparatus for carrying out the information recording method.

### BACKGROUND ART

Conventionally, for viewing of digital video contents or recording of digital data, various types of optical recording media have been widely employed, including CD-DAs, CD-ROMs, CD-Rs, CD-RWs, DVD-ROMs, DVD-Rs, DVD+/−RWs, and DVD-RAMs. On the other hand, these types of optical recording media have been demanded of ever-increasing recording capacities. To meet these requirements, a start has already been made at preparing for the market so-called next-generation DVDs as products that can store massive video images and data. The next-generation DVD has an increased recording capacity which has been achieved by reducing the wavelength of the laser beam, used for recording and reading, to as short as 405 nm.

For example, the Blu-ray Disc (BD) standards or one of the next-generation DVD standards employs a setting of 0.85 for the numerical aperture of the objective lens, thereby enabling recording and reading of 25 GB on a single recording layer.

However, further increases will be expected in the capacity for video images and data in the future. In this context, a technological breakthrough concerning a so-called multi-layered optical recording medium has been suggested to provide it with an increased number of recording surfaces to thereby increase its capacity. Another technology has also been suggested for BD-standard multi-layered optical recording media in Non-Patent Document 1 by I. Ichimura et. al., Appl. Opt., 45, 1794-1803 (2006) or in Non-Patent Document by K. Mishima et. al., Proc. of SPIE, 6282, 62820I (2006). Those recording media are provided with 6- to 8-layer recording surfaces, thereby realizing as very large a capacity as 200 GB.

### DISCLOSURE OF THE INVENTION

### Problems that the Invention is to Solves

In a multi-layered optical recording medium, with respect to a light incident surface, the distance therefrom to the recording surface that is the farthest from this light incident surface is preferably set to 100 μm or less. This is because the spherical aberration compensation range for the pickup is restricted, and with the distance of 100 82 m or more, the margin of disc slope has to be set to be larger. Furthermore, during readout on a recording surface of an optical recording medium with 3 layers or more, signal leakage from adjacent recording layers causes deterioration in signal quality, i.e., occurrence of so-called “inter-layer crosstalk.” The studies conducted by the present inventors show that to prevent interlayer crosstalk from having adverse effects on the read signal, the distance between the recording surfaces has to be set to at least 10 μm or more.

Furthermore, to avoid confocal crosstalk caused by a plurality of the recording surfaces having an equal distance therebetween, the distances between these recording surfaces have to differ from each other. The studies conducted by the present inventors showed that the difference in the distance between these recording surfaces has to be at least 2 μm or more in consideration of the tolerance required for depositing the spacer layers.

From the aforementioned studies, to form a multi-layered optical recording medium having 3 layers or more, the location of each recording surface is subjected to the following restrictions. The recording surface that is the farthest from the light incident surface is located at 100 μm from the light incident surface, and the second recording surface adjacent to this recording surface is located at 90 μm (=100−10) from the light incident surface. Furthermore, the third recording surface adjacent to this recording surface is located at 78 μm (=100−10−12) from the light incident surface, while the fourth recording surface adjacent to this recording surface is located at 66 μm (=100−10−12−14) from the light incident surface. Furthermore, the fifth recording surface adjacent to this recording surface is located at 50 μm (=100−10−12−14−16) from the light incident surface, while the sixth recording surface adjacent to this recording surface is located at 32 μm (=100−10−12−14−16−18) from the light incident surface.

As can be seen from above, the multi-layered optical recording medium is configured such that the recording surfaces are located closer to the light incident surface as the number of the layers increases. However, the closer the recording surface to the light incident surface, the more noticeable the effects that foreign matters, fingerprints, and scratches adhered to the light incident surface have on signal quality become. This causes an increase in error during recording or readout.

The present invention has been achieved in view of the foregoing problem. It is therefore an object of the invention to provide a technique for preventing increases in recording error or decreases in recording capacity due to the presence of foreign matters or scratches on the light incident surface of a multi-layered optical recording medium.

### Means for Solving the Problems

The present inventors clearly showed through intensive studies that the aforementioned object can be achieved by the means below.

In order to achieve the aforementioned object, an information recording method for an optical recording medium according to the present invention is characterized by comprising, when a multi-layered optical recording medium can form information recording layers of 3 layers or more and all the information recording layers are blank, irradiating the information recording layer that is the closest to a light incident surface with a laser beam to start recording.

The information recording method for an optical recording medium that achieves the aforementioned object is characterized in the aforementioned present invention by comprising, when the information recording layer being recorded has been completely recorded, successively carrying out recording on another information recording layer adjacent to that information recording layer and farther away from the light incident surface with respect to that information recording layer.

The information recording method for an optical recording medium that achieves the aforementioned object is characterized in the aforementioned present invention by comprising allowing the information recording layer that is the closest to the light incident surface to be located within 70 μm from the light incident surface.

An information recording apparatus of the present invention that achieves the aforementioned object is an information recording apparatus for irradiating a multi-layered optical recording medium with a laser beam to record information thereon, with the multi-layered optical recording medium being able to form information recording layers of 3 layers or more. The information recording apparatus includes: a recording status detection unit for detecting a recording status of the information recording layer of the multi-layered optical recording medium; a recording surface setting unit for setting the information recording layer to be recorded based on a result of detection by the recording status detection unit; and a laser control unit for irradiating the information recording layer with a laser beam to record information thereon based on an instruction from the recording surface setting unit. The information recording apparatus is characterized in that, when the recording status detection unit has detected that all the information recording layers are blank, the recording surface setting unit sets to record information on the information recording layer that is the closest to the light incident surface.

The information recording apparatus that achieves the aforementioned object is characterized in the aforementioned present invention in that when the recording status detection unit has determined that the information recording layer being recorded has been completely recorded, the recording surface setting unit sets to move on to another light incident surface adjacent to that information recording layer and farther away from the information recording layer with respect to that information recording layer.

### Effect of the Invention

The present invention implemented as the information recording method or the like can provide advantages that given foreign matters such as fingerprints or scratches on the surface of a multi-layered optical recording medium, decreases in its recording capacity or recording rates, which may arise from these factors, can be prevented.

### BRIEF DESCRIPTION OF THE DRAWINGS

FIG. 1 shows a perspective view and an enlarged sectional view illustrating a multi-layered optical recording medium that is employed by an embodiment of the present invention;

FIG. 2 is a cross-sectional view illustrating a status in which information is recorded on each information recording layer of the multi-layered optical recording medium;

FIG. 3 is an enlarged plan view schematically illustrating beam spots formed on a light incident surface of the multi-layered optical recording medium and a foreign matter adhered thereto;

FIG. 4 is a block diagram illustrating the configuration of an information recording apparatus according to an embodiment of the present invention; and

FIG. 5 is a flowchart showing the procedure for recording information using the information recording apparatus.

### BEST MODE FOR CARRYING OUT THE INVENTION

A description will now be given of the embodiments of the present invention in detail with reference to the drawings.

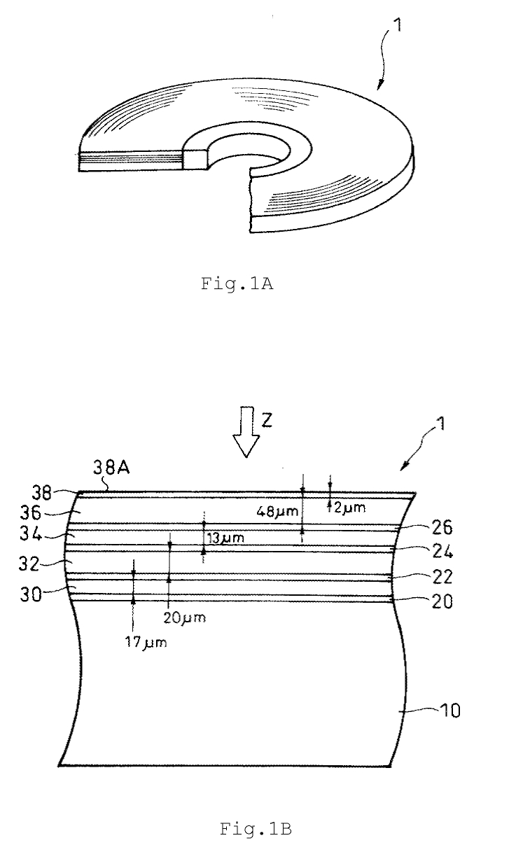

First, with reference to FIG. 1(A), a description will be made to a multi-layered optical recording medium 1 that is used for an information recording apparatus according to a first embodiment of the present invention. This multi-layered optical recording medium 1 is a disc-shaped medium with an outer diameter of about 120 mm and a thickness of about 1.2 mm. As shown in an enlarged view of FIG. 1(B), the multi-layered optical recording medium 1 includes a substrate 10, an L0 information recording layer 20, a first spacer layer 30, an L1 information recording layer 22, a second spacer layer 32, an L2 information recording layer 24, a third spacer layer 34, an L3 information recording layer 26, a cover layer 36, and a hard coat layer 38, which are stacked in that order.

All of the first to third spacer layers 30, 32, and 34, the cover layer 36, and the hard coat layer 38 are optically transparent and thus transmit laser beams that are incident thereon from outside. As a result, a laser beam Z incident upon a light incident surface 38A of the hard coat layer 38 can be used for recording or reading of information on all the L0 to L3 information recording layers 20, 22, 24, 26, and 28.

The L0 information recording layer 20 is the light incident side information recording layer that is the farthest from the light incident surface 38A, whereas the L3 information recording layer 26 is the nearest to the light incident surface 38A. To record or read information on the LO information recording layer 20, the L0 information recording layer 20 is irradiated with the laser beam Z via the L1 to L3 information recording layers 22, 24, and 26. Likewise, to record or read information on the L1 information recording layer 22, the L1 information recording layer 22 is irradiated with a laser beam Z2 via the L2 and L3 information recording layers 24 and 26. To record or read information on the L2 information recording layer 24, the L2 information recording layer 24 is irradiated with a laser beam via the L3 information recording layer 26. To record or read information on the L3 information recording layer 26, the L3 information recording layer 26 is directly irradiated with the laser beam Z not via another information recording layer. Note that this multi-layered optical recording medium 1 is configured such that each of the L0 to L3 information recording layers 20, 22, 24, and 26 has a recording capacity of 25 GB, which sums to a total recording capacity of 100 GB.

The substrate 10 is a disc-shaped member, about 1.1 mm in thickness, which can be made of various raw materials such as glass, ceramics, or resin. In this embodiment, polycarbonate resin was employed. Note that as resins other than polycarbonate resin, it is also possible to employ, for example, olefin resin, acrylic resin, epoxy resin, polystyrene resin, polyethylene resin, polypropylene resin, silicone resin, fluorine-based resin, ABS resin, or urethane resin. Among them, polycarbonate resin or olefin resin can be preferably employed because of the ease of machining or molding. Furthermore, the surface of the substrate 10 on the information recording layer side is provided, as required, with grooves, lands, pit arrays, or the like.

The first to third spacer layers 30, 32, and 34 are stacked between the L0 to L3 information recording layers 20, 22, 24, and 26, respectively, and serve to separate between each of the information recording layers 20, 22, 24, and 26. On the surface of each of the spacer layers 30, 32, and 34 on the light incident surface 38A side, for example, grooves (lands) or pit arrays are formed. The first to third spacer layers 30, 32, and 34 can be formed of various materials; however, as already mentioned, it is necessary to use an optically transparent material to transmit the laser beam Z. For example, it is also preferable to use a UV curable acrylic resin.

Furthermore, this multi-layered optical recording medium 1 is configured such that the first spacer layer 30 has a thickness of 17 82 m, the second spacer layer 32 has a thickness of 20 μm, and the third spacer layer 34 has a thickness of 13 μm, and thus these layers are set to be at least 10 μm or more. Furthermore, the plurality of spacer layers 30, 32, and 34 are different from each other in thickness as mentioned above, thereby making it possible to reduce interference between read signals as well as noise of readout signals. This difference in thickness should be preferably at least 2 μm or more. Note that the hard coat layer 38 is set to have a thickness of 2 μm and the cover layer 36 is set to have a thickness of 48 μm. As seen from above, for the information recording layers 20, 22, 24, and 26 stacked in multiple layers, in order to allow a sufficiently enough intensity of the laser beam Z to reach the L0 information recording layer 20 that is the farthest from the light incident surface 38A, the light transmission characteristics of the other information recording layers 22, 24, and 26 have to be increased.

Accordingly, this multi-layered optical recording medium 1 is designed such that the distance from the light incident surface 38A to the L3 information recording layer 26 is about 50 μm; the distance from the light incident surface 38A to the L2 information recording layer 24 is about 63 μm; the distance from the light incident surface 38A to the L1 information recording layer 22 is about 83 μm; and the distance from the light incident surface 38A to the L0 information recording layer 20 is about 100 μm. This shows that the L0 information recording layer 20 is compatible to the Blu-ray Disc (Blu-ray Disc) standards including its recording capacity (25 GB).

These L0 to L3 information recording layers 20, 22, 24, and 26 are layers for retaining data. The scheme of retaining data is of a so-called writable type which allows the user to write data. In more detail, this writable type is divided into a write-once type which does not allow overwriting of data on an area on which data has been previously written; and a rewritable type which allows deleting of written data and overwriting of new data on that area. This embodiment can employ either type. It is also possible for the information recording layers 20, 22, 24, and 26 to retain data in different manners.

Note that although not specifically illustrated, the L0 to L3 information recording layers 20, 22, 24, and 26 are provided with spiral grooves and lands. The grooves serve as a guide track for the laser beam Z during data recording, so that the energy intensity of the laser beam Z travelling along the grooves is modulated, thereby forming record marks on the information recording layers 20, 22, 24, and 26 on the grooves. Note that in the case of the write-once type for retaining data, the record marks are formed irreversibly and thus cannot be erased. On the other hand, in the case of the rewritable type for retaining data, record marks are formed reversibly so that they can be erased and re-formed. The record marks can be formed on the lands or both on the grooves and lands.

A description will now be made to the effects that foreign matters adhered to the surface have on the recording of a signal on the multi-layered optical recording medium 1.

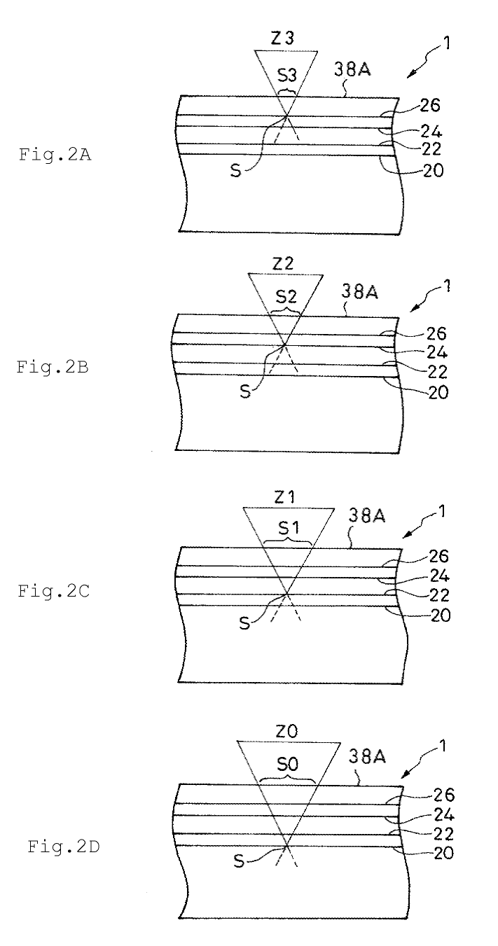

To record data on the multi-layered optical recording medium 1 constructed in this manner, the recording laser beam Z that is incident on the light incident surface 38A is focused on the L0 to L3 information recording layers 20, 22, 24, and 26. For example, as shown in FIG. 2(A), to record on the L3 information recording layer 26, focus control is provided so that the beam spot S of the laser beam Z3 is substantially minimized on the L3 information recording layer 26. At this time, on the light incident surface 38A, an intermediate beam spot S3 that is greater than the beam spot S is formed by the laser beam Z3. Furthermore, as shown in FIG. 2(B), to record on the L2 information recording layer 24, focus control is provided so that the beam spot of the laser beam Z2 is substantially minimized on this L2 information recording layer 24. At this time, an intermediate beam spot S2 that is greater than the beam spot S is formed by the laser beam Z2 on the light incident surface 38A. As shown in FIG. 2(C), to record on the L1 information recording layer 22, focus control is provided so that the beam spot of the laser beam Z1 is substantially minimized on this L1 information recording layer 22. At this time, an intermediate beam spot S1 that is greater than the beam spot S is formed by the laser beam Z1 on the light incident surface 38A. As shown in FIG. 2(D), to record on the L0 information recording layer 20, focus control is provided so that the beam spot of the laser beam Z0 is substantially minimized on this L0 information recording layer 20. At this time, an intermediate beam spot S0 that is greater than the beam spot S is formed by the laser beam Z0 on the light incident surface 38A.

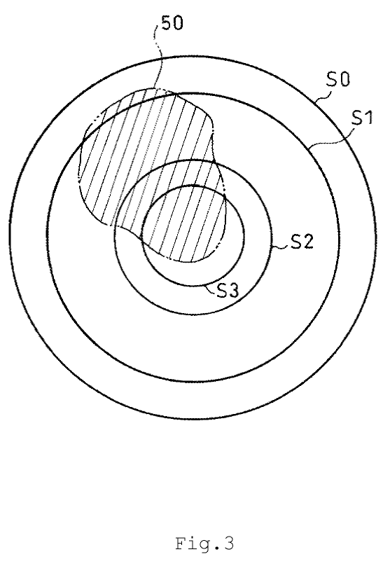

FIG. 3 shows a comparison made between the sizes of the intermediate beam spots S0 to S3 formed on the light incident surface 38A. It can be seen that the intermediate beam spot S3 is the smallest in size and followed by S2, S1, and S0 in ascending order of size. This is because the focus (laser spot S) is more separated from the light incident surface 38A with increasing distance from the light incident surface 38A to the information recording layers 20, 22, 24, and 26. While the user carries the multi-layered optical recording medium 1 with her/him or inserts it into a read/write apparatus, a foreign matter 50 such as fingerprints or dust particles will be adhered to or scratches may be made on the light incident surface 38A. The foreign matter 50 may cause deterioration in the recording characteristics of the multi-layered optical recording medium 1. In particular, with increasing ratios of the foreign matter 50 to the intermediate beam spots S0 to S3 formed on the light incident surface 38A, record marks are formed less sufficiently because the energy of the recording laser beam Z is blocked with the foreign matter 50. Accordingly, the L3 information recording layer 26 can be said to be susceptible to the foreign matter 50. In particular, according to the BD standards, the information recording layer located within 70 μm from the light incident surface 38A causes the ratio of the foreign matter 50 to be higher to a non-negligible level.

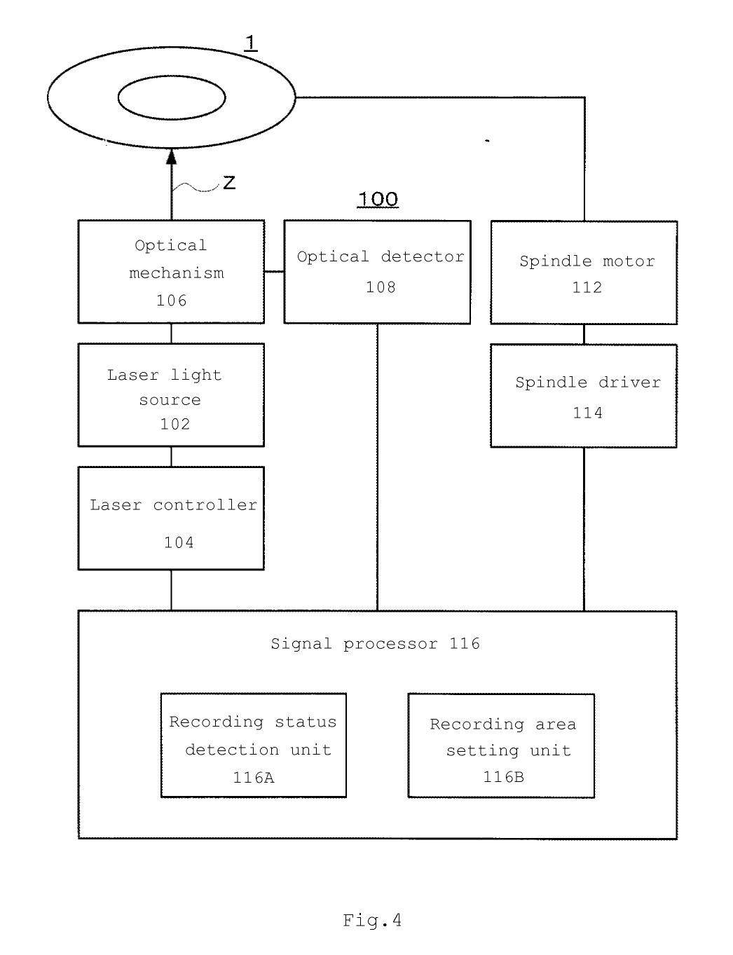

Now, with reference to FIG. 4, a description will be made to an information recording apparatus 100 that realizes an information recording method of this embodiment. The information recording apparatus 100 includes: a laser light source 102 for emitting a laser beam Z used for recording or reading; a laser controller 104 for controlling the laser light source 102; an optical mechanism 106 for guiding the laser beam Z to the multi-layered optical recording medium 1; an optical detector 108 for detecting a reflected beam of the laser beam Z; a spindle motor 112 for rotating the multi-layered optical recording medium 1; a spindle driver 114 for controlling the rotation of the spindle motor 112; and a signal processor 116 for communicating signal data with a CPU (Central Processing Unit—not shown) and providing recording and reading control based on write signal data and read signal data. The signal processor 116 includes a recording status detection unit 116A for detecting the recording status of an information recording layer of the multi-layered optical recording medium 1, and a recording area setting unit 116B for setting a recording area on which recording is to be performed among a plurality of information recording layers.

The laser light source 102 is a semiconductor laser and controlled by the laser controller 104 to produce the laser beam Z. The optical mechanism 106 includes a half mirror and an objective lens (not shown), and can focus the laser beam Z on the L0 to L3 information recording layers 20, 22, 24, and 26, as appropriate. Note that the half mirror directs the reflected beams from the L0 to L3 information recording layers 20, 22, 24, and 26 into the optical detector 108. The optical detector 108 is a photo-detector which receives a reflected beam of the laser beam Z and then outputs it as a signal. The signal is supplied to the signal processor 116 and used as control data and read signal data, and part of it is delivered to the CPU (not shown).

To record the signal data supplied by the CPU on the multi-layered optical recording medium 1, the laser controller 104 controls the laser light source 102, based on the instruction from the signal processor 116 that has received the signal data, to generate the predetermined laser beam Z. The laser beam Z is guided by the optical mechanism 106 and used as a laser spot to irradiate either one of the L0 to L3 information recording layers 20, 22, 24, and 26. The energy of this laser spot serves to form record marks on the L0 to L3 information recording layers 20, 22, 24, and 26.

On the other hand, to read the information recorded on the multi-layered optical recording medium 1, a read laser beam is produced from the laser light source 102, and then this read laser beam is used to irradiate a particular location of the L0 to L3 information recording layers 20, 22, 24, and 26. The read laser beam is reflected on the L0 to L3 information recording layers 20, 22, 24, and 26, and then directed via the optical mechanism 106 into the optical detector 108, so that it passes through the signal processor 116 and is supplied to the CPU as the read signal.

The recording status detection unit 116A detects the information recording status of the L0 to L3 information recording layers 20, 22, 24, and 26. More specifically, it can detect either which of the L0 to L3 information recording layers 20, 22, 24, and 26 has finished the previous information recording operation or the respective recording capacity (the remaining capacity) of the L0 to L3 information recording layers 20, 22, 24, and 26. Note that as used herein, the expression “being blank” refers to the status in which no user data has been recorded on each of the L0 to L3 information recording layers 20, 22, 24, and 26. On the other hand, as used herein, the expression “completely recorded” refers to the status in which a recording operation has been completed over the entire area which can retain user data, on each of the L0 to L3 information recording layers 20, 22, 24, and 26.

These recording statuses are preferably detected by reading out various types of information that was completely recorded previously in the read-in area or read-out area. However, it is also possible to directly read and detect the recording status of the L0 to L3 information recording layers 20, 22, 24, and 26. If no information was recorded on any one of the L0 to L3 information recording layers 20, 22, 24, and 26 so far, then this multi-layered optical recording medium 1 can be determined to be a perfect blank disc.

At the start of recording of information or the like, the recording surface setting unit 116B makes use of a result of detection by the aforementioned recording status detection unit 116A to select the information recording layer to be recorded from among the L0 to L3 information recording layers 20, 22, 24, and 26. For example, when the multi-layered optical recording medium 1 is inserted into the information recording apparatus 100 to start recording of information, the information recording layer on which the recording is to be started is selected from among the L0 to L3 information recording layers 20, 22, 24, and 26. Furthermore, for example, while information is being recorded on a particular information recording layer, this information recording layer may have been completely recorded, i.e., a recording operation may have been completed on all the recording areas. In this case, the information recording layer on which recording is subsequently performed is selected from among the L0 to L3 information recording layers 20, 22, 24, and 26.

In particular, the recording surface setting unit 116B decides, as its first functionality, to record information on the L3 information recording layer 26 that is the closest to the light incident surface 38A when the recording status detection unit 116A has detected that all of the L0 to L3 information recording layers 20, 22, 24, and 26 are blank. As already mentioned, since the L3 information recording layer 26 is located within 70 μm from the light incident surface 38A, the information recording quality can easily be deteriorated due to the presence of a foreign matter or a scratch on its surface. Accordingly, recording is performed preferentially on the L3 information recording layer 26 from the beginning of use of the medium, thereby allowing for recording at an earlier stage at which there are comparatively fewer fingerprints or scratches.

Furthermore, when a particular one of the L0 to L3 information recording layers 20, 22, 24, and 26 has been completely recorded, the recording surface setting unit 116B sets, as its second functionality, to successively write information on one of the L0 to L3 information recording layers 20, 22, 24, and 26 that is adjacent to that information recording layer and farther away from the light incident surface 38A with respect to that information recording layer. For example, when the aforementioned first function allowed for starting recording on the L3 information recording layer 26 and then the L3 information recording layer 26 has been completely recorded, the second function successively carries out recording of information on the L2 information recording layer 24 that is adjacent to the L3 information recording layer 26. After that, if the L2 information recording layer 24 has been completely recorded, then recording of information is also successively carried out on the L1 information recording layer 22 that is adjacent to the L2 information recording layer 24.

It is therefore possible for the aforementioned first and second functions to record information on each of the information recording layers in order from the one closest to the light incident surface 38A.

Note that a device different from the information recording apparatus 110 may be possibly used to record information distributively on the L0 to L3 information recording layers 20, 22, 24, and 26 of the multi-layered optical recording medium 1. When such a multi-layered optical recording medium 1 is inserted into the information recording apparatus 110, the recording status detection unit 116A detects the respective remaining recording areas of the L0 to L3 information recording layers 20, 22, 24, and 26. Based on the detection result, the recording surface setting unit 116B sets, as a recording start surface, the information recording layer that is the closest to the light incident surface 38A among the remaining recording areas. This allows for recording even on the remaining recording areas in the order from the one closest to the light incident surface 38A.

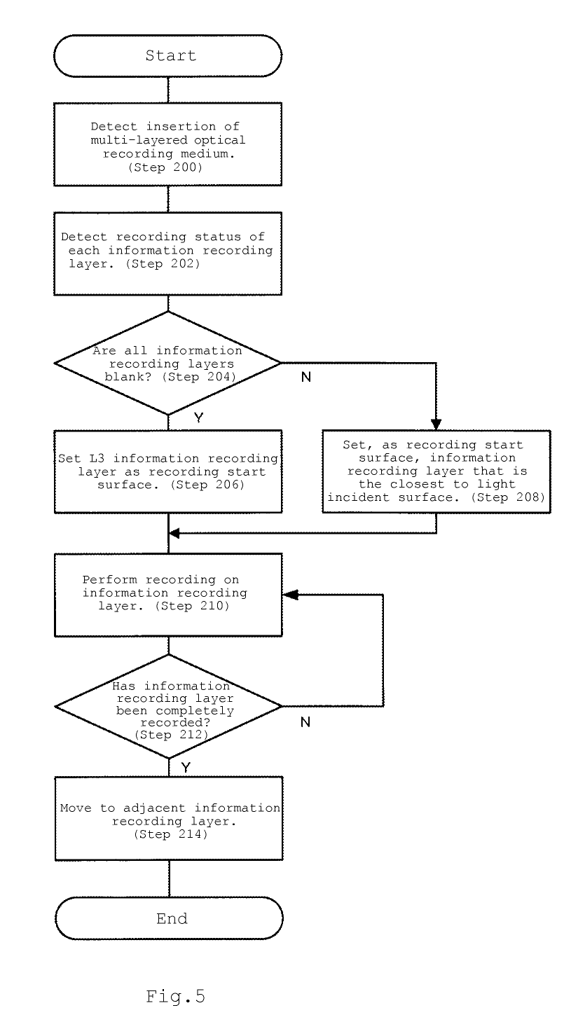

FIG. 5 is a flowchart showing the procedure for recording information using this information recording apparatus 100.

Initially, in step 200, the process determines whether the intended multi-layered optical recording medium 1 has been inserted into the apparatus. After that, in step 202, the recording status detection unit 116A reads out the read-in area or read-out area of this multi-layered optical recording medium 1 to detect the recording status of the L0 to L3 information recording layers 20, 22, 24, and 26.

In step 204, the recording surface setting unit 116B determines whether all the L0 to L3 information recording layers 20, 22, 24, and 26 of the multi-layered optical recording medium 1 are blank. If so, then in step 206, the L3 information recording layer 26 that is the closest to the light incident surface 38A is set as a recording start surface. On the other hand, if it is determined in step 204 that the L0 to L3 information recording layers 20, 22, 24, and 26 are not blank, then in step 208, based on the vacant areas of the L0 to L3 information recording layers 20, 22, 24, and 26, the information recording layer that is the closest to the light incident surface 38A among those vacant areas is set as the recording start surface.

After the recording start surface has been determined, then in step 210, recording of information is started on the recording start surface that has been set. After that, when it is determined in step 212 that the information recording layer being recorded has been completely recorded, then in step 214, information is successively recorded on the adjacent information recording layer that is farther away from the light incident surface 38A with respect to that information recording layer. If the successive information recording layer has been completely recorded, the recording operation moves on to the adjacent information recording layer, for successively and completely recording information thereon, which is farther away from the light incident surface 38A with respect to that information recording layer.

The information recording method of the present embodiment is configured to record successively on the recording surface closer to the light incident surface 38A in the multi-layered optical recording medium 1 that has information recording layers of 3 layers or more. As already mentioned above, recording on the information recording layer that is closer to the light incident surface 38A is likely unstable due to significant variations in the energy of the recording laser beam caused, for example, by the presence of foreign matters or the like. Accordingly, as a result of use of this information recording method, recording of information can be completed on the information recording layer (for example, one of the L2 and L3 information recording layers 24 and 26) that is the closest to the light incident surface 38A before foreign matters such as fingerprints are adhered to or scratches are made on the multi-layered optical recording medium 1. It is thus possible to improve the information recording quality.

On the other hand, those information recording layers that are far away from the light incident surface 38A (for example, the L0 information recording layer 20) is less susceptible to deterioration in recording quality even in the presence of fingerprints or scratches on the light incident surface 38A. Accordingly, information can be still recorded with stability even for a comparatively longer period of time after the start of use of the multi-layered optical recording medium 1. As a result, the information recording method makes it possible to increase the recording capacity of information by reducing recording errors even in the multi-layered optical recording medium 1 that has 3 layers or more.

Furthermore, since recording error can be reduced, it is possible to record information at a substantially increased rate.

As described above, for the information recording apparatus of the present embodiment, such an example was illustrated in which 4 or more layers are formed within as very narrow a range as about 100 μm from the light incident surface. However, the present invention is not limited thereto. It is also possible to locate an information recording layer at 100 μm or farther point. Furthermore, in the present embodiment, such an example was illustrated in which the number of information recording layers of the multi-layered optical recording medium is limited to four layers. However, the present invention is not limited thereto, and 3 layers or more may also be employed.

Furthermore, the multi-layered optical recording medium 1 of the present embodiment illustrated has on each information recording layer a recording layer, which varies in state when being irradiated with a laser beam. However the present invention is not limited thereto. For example, the basis material itself of the optical recording medium is a monolithic structure having a predetermined thickness. But, it is also possible to employ a so-called volume written recording medium in which when the basis material is irradiated with a laser beam, only a portion thereof on which the beam spot is focused changes in state for recording data. That is, the multi-layered optical recording medium of the present invention is not limited to a structure in which the recording layer to be irradiated with a laser beam is pre-formed in multiple layer stacking but also include one in which record marks are formed, as required, at a location separated from the light incident surface by a predetermined distance, and multi-layered information recording layers are constructed post hoc as a collection of those record marks.

Note that the information recording apparatus of the present invention is not limited to the aforementioned embodiments, but may of course be modified in a variety of ways without deviating from the scope of the present invention.

### INDUSTRIAL APPLICABILITY

The present invention provides high-quality recording or reading, without reducing recording capacity, for multi-layered optical recording media which can form three or more layers of information recording layers.

1. An information recording method for an optical recording medium, the method comprising, when a multi-layered optical recording medium can form information recording layers of 3 layers or more and all the information recording layers are blank, irradiating the information recording layer that is the closest to a light incident surface with a laser beam to start recording.

2. The information recording method for an optical recording medium according to claim 1, comprising, when the information recording layer being recorded has been completely recorded, successively carrying out recording on another information recording layer adjacent to that information recording layer and farther away from the light incident surface with respect to that information recording layer.

3. The information recording method for an optical recording medium according to claim 1, comprising allowing the information recording layer that is the closest to the light incident surface to be located within 70 μm from the light incident surface.

4. An information recording apparatus for irradiating a multi-layered optical recording medium with a laser beam to record information thereon, with the multi-layered optical recording medium being able to form information recording layers of 3 layers or more, the information recording apparatus comprising:
a recording status detection unit for detecting a recording status of the information recording layer of the multi-layered optical recording medium;
a recording surface setting unit for setting the information recording layer to be recorded based on a result of detection by the recording status detection unit; and
a laser control unit for irradiating the information recording layer with a laser beam to record information thereon based on an instruction from the recording surface setting unit, wherein
when the recording status detection unit has detected that all the information recording layers are blank, the recording surface setting unit sets to record information on the information recording layer that is the closest to the light incident surface.

5. The information recording apparatus according to claim 4, wherein, when the recording status detection unit has determined that the information recording layer being recorded has been completely recorded, the recording surface setting unit sets to move on to another light incident surface adjacent to that information recording layer and farther away from the information recording layer with respect to that information recording layer.
